(19) United States
(12) Patent Application Publication
(10) Pub. No.: US 2007/0062357 A1
(43) Pub. Date: Mar. 22, 2007

(54) Paper cutting device

(76) Inventor: Lisa M. Pedrys, Osceola, WI (US)

Correspondence Address: Curtis D. Kinghorn;Sirius Strategic, LLC, 6769 W. Shadow Lake Dr., Lino Lakes, MN, 55014, US

(21) Appl. No.: 11/231,474

(22) Filed: Sep. 21, 2005

(51) Int. Cl. B26D 5/08

(52) U.S. Cl. 83/605

(57) ABSTRACT

A paper trimmer is described having removable stationary cutting blades and cutting members. The removable stationary cutting blades and cutting members have shapes along their respective edges where the respective edges interact to cut the paper. These shapes take the form of corresponding patterns that are not in the form of a single straight line. As a result, decorative patterns may be applied to or cut into the edges of the paper to be trimmed by the operation of the paper trimmer. When a different pattern is desired, the user removes the current stationary cutting blade and its corresponding cutting member and replaces them with the newly desired stationary cutting blade and its corresponding cutting member.

### BACKGROUND OF THE INVENTION

1. Field of the Invention

The present invention is directed to paper cutting devices and more particularly to paper cutting devices that have a stationary blade and a movable blade that moves to contact the stationary blade and cut paper by a shearing motion.

2. Description of Related Art

Scrapbooking has become a very popular hobby. It is estimated that a quarter of US households participate in scrapbooking. As a result, scrapbooking has become an industry exceeding $1.5 billion in annual sales.

Of those households that participate in scrapbooking, it is also estimated that nine percent of such households have a person who spends two or more hours a week on scrapbooking projects. Consequently, many different tools have been created to assist scrapbookers in pursuing this hobby. One group of tools are scissors that are used to cut the edges of documents, pictures, etc. with decorative patterns. Example of such scissors are U.S. Pat. No. 4,250,619 entitled “Pinking Scissors with Replaceable Blades” issued to Antoinette P. Buerkert and George T. Hughes on Feb. 17, 1981 and U.S. Pat. No. 5,758,422 entitled “Scissors with Interchangeable Blades” issued to Lisa Deborah Frank on Jun. 2, 1998. One problem with such a system for creating decorative edges is that the user must determine and maintain the appropriate location for the cutting that results in the decorative pattern. This is often difficult to do with the precision many users desire.

Paper trimmers are known to cut or trim the edges of paper to produce paper of a desired size. Examples of such trimmers are disclosed in U.S. Pat. No. 118,419 issued Aug. 22, 1871 to R. O. Wood entitled “Cutting Shears”, U.S. Pat. No. 639,231 issued Dec. 19, 1899 to O. C. Hale entitled “Paper Cutter”, U.S. Pat. No. 2,185,985 issued Jan. 2, 1940 to F. M. Lund entitled “Trimming Board”, U.S. Pat. No. 2,238,857 issued Apr. 15, 1941 to W. H. Ford entitled “Card Trimmer”, U.S. Pat. No. 2,254,374 issued Sep. 2, 1941 to A. Laukhuff entitled “Cutting Machine”, U.S. Pat. No. 2,345,450 issued Mar. 28, 1944 to A. I. Blanc entitled “Trimming Board”, U.S. Pat. No. 3,089,373, issued May 14, 1963 to E. F. Fisher et al. entitled “Paper Trimmer”, U.S. Pat. No. 3,792,636 issued Feb. 19, 1974 to Alvin R. Pottern entitled “Paper Trimmer”, U.S. Pat. No. 4,957,235 issued Sep. 18, 1990 to Steven J. Benos and Joseph R. Mango entitled “Paper Trimmer” and U.S. Pat. No. 5,887,505 issued Mar. 30, 1999 to Louis P. Mathian entitled “Office Guillotine for Cutting Tabs”, the teachings of which are incorporated into this application by reference in their entirety.

FIGS. 1-5 show an exemplary prior art paper trimmer generally labeled 10. Paper trimmers 10 are comprised of the following fundamental elements as shown in the drawings: a platform 12 having a stationary cutting blade 14. A movable cutting arm 16 is connected to the platform 12 by a pivot 18. The stationary cutting blade 14 interacts with the movable cutting arm 16 to cut the paper that is desired to be cut.

Platform 12 has a planar top surface 20 which top surface 20 has a size sufficiently large to substantially hold the paper or page that is desired to be trimmed by trimmer 10. Platform 12 also has a bottom surface 22 opposite top surface 20. Platform 12 is usually made of wood or plastic although steel, aluminum, ceramics or other lightweight materials are also used.

The top surface 20 is usually square or rectangular in shape and has an upper side 24, a lower side 26, a cutting edge 28 and an opposed edge 30. Upper side 24 and lower side 26 are located opposite each other and cutting edge 28 and opposed edge 30 are located opposite each other. Platform 12 also has a platform recess 32 extending along the cutting edge 28 of top surface 20. Platform recess 32 has the form of a shallow rabbet and has an upper surface 34.

Top surface 20 typically has parallel lines 36 printed on or cut or formed in it at desired distances to delineate desirable distances or sizes of paper. Such lines 36 are usually evenly spaced at predetermined distances and extend both from upper side 24 to lower side 26 and from cutting edge 28 to opposed edge 30, crossing each other at right angles, so that a series of rectangles are formed.

The bottom surface 22 of platform 12 often lays flat on the surface upon which it is placed or may have legs 38 attached to it to position platform 12 above such surface. Legs 38 are often integrally formed with platform 12 or attached to bottom surface 22 by means such as screws and adhesives.

Stationary cutting blade 14 is a horizontally-disposed stationary cutting blade attached to the top surface 20 along the a cutting edge 28. Stationary cutting blade 14 is usually located in platform recess 32. Stationary cutting blade 14 has a top surface 40, a bottom surface 42 and a cutting edge 44. Stationary cutting blade 14 is located in the platform recess 32 along cutting edge 28 so that the bottom surface 42 contacts the upper surface 34 of platform recess 32 and the top surface 40 of stationary cutting blade 14 is co-planar with the top surface 20. Cutting edge 44 in the prior art paper trimmers is a straight cutting edge that interacts with the movable cutting arm 16 as will be described hereafter. Cutting edge 44 typically has a very well defined edge (i.e., the edge has a well defined 90° angle as its ultimate edge).

Stationary cutting blade 14 is sometimes held permanently in place in platform recess 32 by adhesives or rivets. However, stationary cutting blade 14 is sometimes held in place in platform recess 32 by relatively permanent means such as screws 46 that extend through holes 48 in stationary cutting blade 14 into the upper surface 34 of platform recess 32 where holes 50 in the upper surface 34 receive the screws 46 and have a thread to match and interact with the threads on screws 46. The heads 52 of screws 46 and the holes 48 extending through stationary cutting blade 14 to accommodate screws 46 are formed so that when screws 46 are located in holes 48 and holes 50, and are thereby holding stationary cutting blade 14 in place in platform recess 32, the heads 52 of screws 46 are also coplanar with the top surface 40 of stationary cutting blade 14.

Movable cutting arm 16 is vertically disposed and movable to interact with stationary cutting blade 14 through a cutting member 54. Movable cutting arm 16 has a lower edge 56, a pivot end 58 and a handle end 60. Cutting member 54 has a cutting edge 62. Cutting edge 62 is formed to complement cutting edge 44 of stationary cutting blade 14 so that cutting edge 62 interacts with cutting edge 44 to cut the paper or other object to be cut by a shearing action. Cutting member 54 is sometimes integrally formed with movable cutting arm 16 but sometimes also is removable from movable cutting arm 16. Where cutting member 54 is removable, cutting member 54 has a first end 64, a second end 66, a top surface 68 and a bottom surface 70.

Where cutting member 54 is removable, cutting member 54 is typically held in place in contact with movable cutting arm 16 by relatively permanent means such as screws 72 that extend through holes 74 in cutting member 54 into movable cutting arm 16. Movable cutting arm 16 has a series of holes 76 positioned to be aligned with holes 74 and having threads matching the threads of screws 72. The heads 78 of screws 72 and the holes 74 extending through cutting member 54 to accommodate screws 72 are formed so that when screws 72 are located in holes 74 and holes 76, and are thereby holding cutting member 54 in place against movable cutting arm 16 so that the bottom surface 70 of the cutting member 54 contacts the movable cutting arm 16, the heads 78 of screws 72 are also coplanar with the top surface 68 of cutting member 54. Cutting edge 62 in the prior art paper trimmers is a single straight cutting edge that interacts with the straight cutting edge 44 as will be described hereafter. Cutting edge 62 typically has a very well defined edge (i.e., the edge has a well defined 90° angle as its ultimate edge).

Movable cutting arm 16 is attached to platform 12 by a pivot 18. Pivot 18 secures movable cutting arm 16 to platform 12 and allows movable cutting arm 16 to move around pivot 18 to perform the cutting operation as will be described hereafter. Pivot 18 includes a pivot shaft 80 having a first end 82 and a second end 84. The first end 82 of pivot shaft 80 is attached to cutting member 54 at first end 64 of cutting member 54 at a right angle to cutting member 54. Pivot shaft 80 itself may be either integrally formed with cutting member 54 or fixed to cutting member 54 at the first end 82 of pivot shaft 80. The second end 84 of pivot shaft 80 is typically threaded to receive a nut 86 to prevent pivot shaft from moving out of contact with a housing 88.

Platform 12 typically includes a housing 88 that receives and holds the second end 84 of pivot shaft 80 and thereby acts as a trunnion. Housing 88 is often attached to platform 12 at the upper side 24 of platform 12 near the cutting edge 28 of platform 12 by means such as screws or adhesives. Housing 88 includes an aperture 90 sized to receive the first end 82 of pivot shaft 80 so that pivot shaft 80 may rotate in and be constrained in aperture 90. In this way, housing 88 acts as a bearing lug for the rotational motion of the pivot shaft 80 relative to the housing 88 and the platform 12.

Movable cutting arm 16 usually has a handle 92 attached to the first end 82 of cutting body 14. Handle 92 may be angled somewhat with respect to cutting member 54 so as to be more ergonomic for the user.

Movable cutting arm 16 therefore moves in a vertical plane by pivoting around pivot 18 so that cutting edge 62 on movable cutting arm 16 contacts and interacts with cutting edge 44 of stationary cutting blade 14 to produce a shearing cut along any paper placed along the cutting edge 44. As a result of this shearing cut, any material located outside of the cutting edge 44 is separated from the paper located on the top surface 20 of platform 12 along a straight line. However, it would be useful to be able to cut paper with a paper trimmer as described so that the resulting cut line is in a pattern other than a single straight line.

### SUMMARY OF THE INVENTION

A paper trimmer is described having removable stationary cutting blades and cutting members. The removable stationary cutting blades and cutting members have shapes along their respective edges where the respective edges interact to cut the paper. These shapes take the form of corresponding patterns that are not in the form of a single straight line. As a result, decorative patterns may be applied to or cut into the edges of the paper to be trimmed by the operation of the paper trimmer. When a different pattern is desired, the user removes the current stationary cutting blade and its corresponding cutting member and replaces them with the newly desired stationary cutting blade and its corresponding cutting member.

It is therefore an object of the invention to provide a paper trimmer that is capable of producing multiple decorative cutting patterns.

It is also an object of the invention, in one embodiment, to provide a paper trimmer that is capable of producing multiple decorative cutting patterns where the patterns may be changed in a relatively easy manner.

These and other objects of the invention will be clear from the description contained herein and particularly with reference to the following Detailed Description of the Invention and the associated Drawings.

### BRIEF DESCRIPTION OF THE DRAWINGS

FIG. 1 is a top view of a prior art paper trimmer.

FIG. 2 is a side view of a prior art movable cutting arm.

FIG. 3 is an end view of a platform and stationary cutting blade of a prior art paper trimmer.

FIG. 4 is an end exploded view of a platform and stationary cutting blade of the prior art paper trimmer of FIG. 3.

FIG. 5 is an end view of a platform and stationary cutting blade of another prior art paper trimmer.

FIG. 6 is an end exploded view of a platform and stationary cutting blade of the prior art paper trimmer of FIG. 5.

FIG. 7 is plan view of the stationary cutting blade and the cutting member of a prior art paper trimmer.

FIG. 8 is plan view of an embodiment of the stationary cutting blade and the cutting member of the present invention.

FIG. 9 is plan view of an embodiment of the stationary cutting blade and the cutting member of the present invention.

FIG. 10 is plan view of an embodiment of the stationary cutting blade and the cutting member of the present invention.

FIG. 11 is plan view of an embodiment of the stationary cutting blade and the cutting member of the present invention.

FIG. 12 is plan view of an embodiment of the stationary cutting blade and the cutting member of the present invention.

FIG. 13 is a perspective view of an embodiment of a movable cutting arm of the present invention.

FIG. 14 is a top view of an embodiment of the present invention.

FIG. 15 is a side view of an embodiment of the movable cutting arm of the present invention.

FIG. 16 is a side view of a platform of the embodiment of the invention of FIG. 14.

FIG. 17 is a side view of a stationary cutting blade of the embodiment of the invention of FIG. 14.

FIG. 18 is a bottom view of a movable cutting arm of the embodiment of the invention of FIG. 14 without the cutting member in place.

FIG. 19 is a bottom view of a cutting member of the embodiment of the invention of FIG. 14.

FIG. 20 is a side view of a platform of an embodiment of the invention of FIG. 14.

FIG. 21 is a side view of a stationary cutting blade of the embodiment of the invention of FIG. 14.

FIG. 22 is a bottom view of a movable cutting arm of the embodiment of the invention of FIG. 14 without the cutting member in place.

FIG. 23 is a bottom view of a cutting member of the embodiment of the invention of FIG. 14.

FIG. 24 is a bottom view of a cutting member of the embodiment of the invention of FIG. 14.

FIG. 25 is a bottom view of another cutting member of the embodiment of the invention of FIG. 14.

FIG. 26 is a side view of a platform of an embodiment of the invention of FIG. 14.

FIG. 27 is a side view of a stationary cutting blade of the embodiment of the invention of FIG. 14.

FIG. 28 is a bottom view of a movable cutting arm of the embodiment of the invention of FIG. 14 without the cutting member in place.

FIG. 29 is a bottom view of a cutting member of the embodiment of the invention of FIG. 14.

FIG. 30 is a side view of a platform of an embodiment of the invention of FIG. 14.

FIG. 31 is a side view of a stationary cutting blade of the embodiment of the invention of FIG. 14.

FIG. 32 is a bottom view of a movable cutting arm of the embodiment of the invention of FIG. 14 without the cutting member in place.

FIG. 33 is a bottom view of a cutting member of the embodiment of the invention of FIG. 14.

FIG. 34 is a top view of the intermeshing of a stationary cutting blade and cutting member of the embodiment of the invention of FIG. 14.

FIG. 35 is a top view of the intermeshing of another stationary cutting blade and cutting member of the embodiment of the invention of FIG. 14.

FIG. 36 is a top view of the intermeshing of another stationary cutting blade and cutting member of the embodiment of the invention of FIG. 14.

FIG. 37 is a top view of the intermeshing of another stationary cutting blade and cutting member of the embodiment of the invention of FIG. 14.

FIG. 38 is a top view of the intermeshing of another stationary cutting blade and cutting member of the embodiment of the invention of FIG. 14.

FIG. 39 is a top view of the intermeshing of another stationary cutting blade and cutting member of the embodiment of the invention of FIG. 14.

FIG. 40 is a top view of the intermeshing of another stationary cutting blade and cutting member of the embodiment of the invention of FIG. 14.

FIG. 41 is a side view of a platform of the embodiment of the invention with a drawer.

FIG. 42 is a top view of a platform of the embodiment of the invention with a drawer.

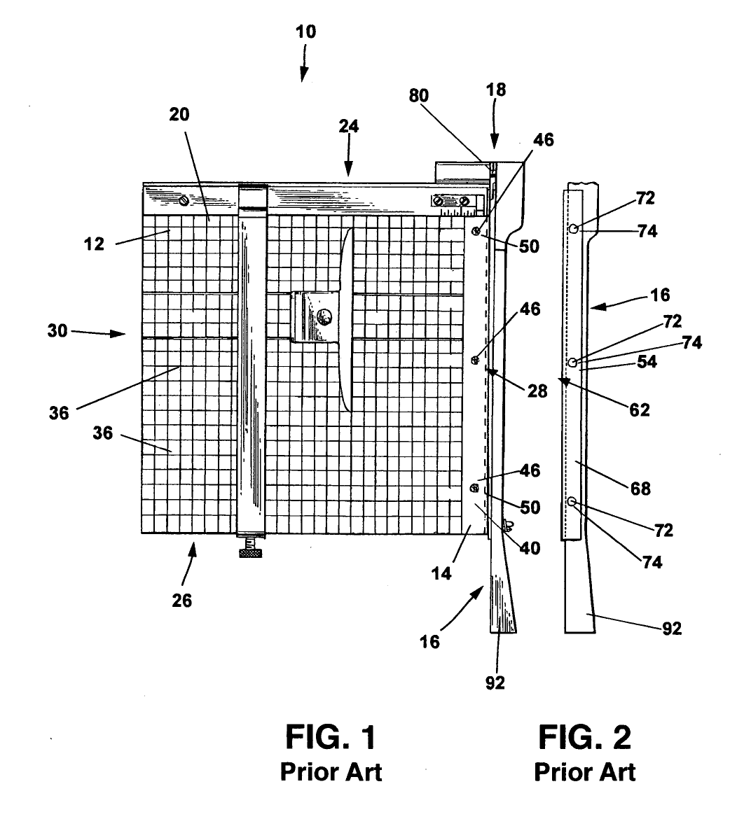

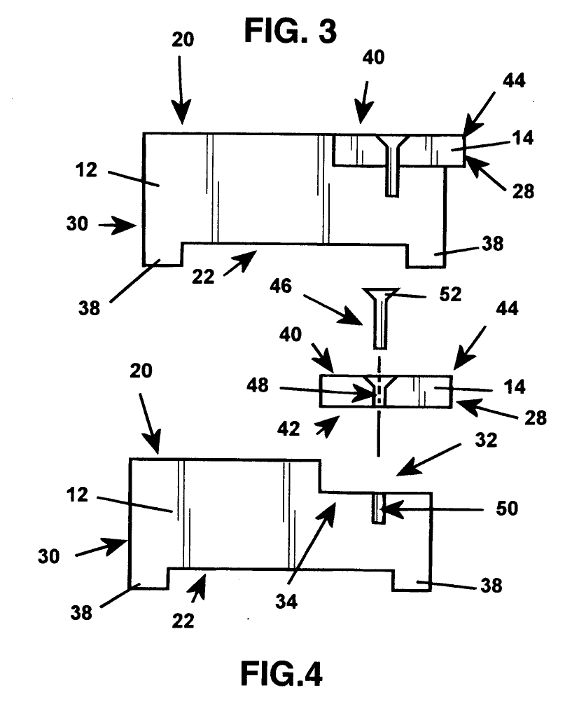

### DETAILED DESCRIPTION OF THE INVENTION

The present invention modifies a paper trimmer such as the prior art paper trimmers described above. Throughout the description, like members, elements or parts, wherever referenced or described, are referred to by like reference numbers. Unless otherwise described, the description and functioning of an element set out in one portion of the application, including the description of the prior art, applies to the element referred to by the same reference number in another portion of the description including in this Detailed Description of the Invention. Further, the present description includes description of several embodiments of the invention. Again, reference to or description of an element in connection with one embodiment refers to the physical attributes, characteristics or function of an element wherever set forth in the description.

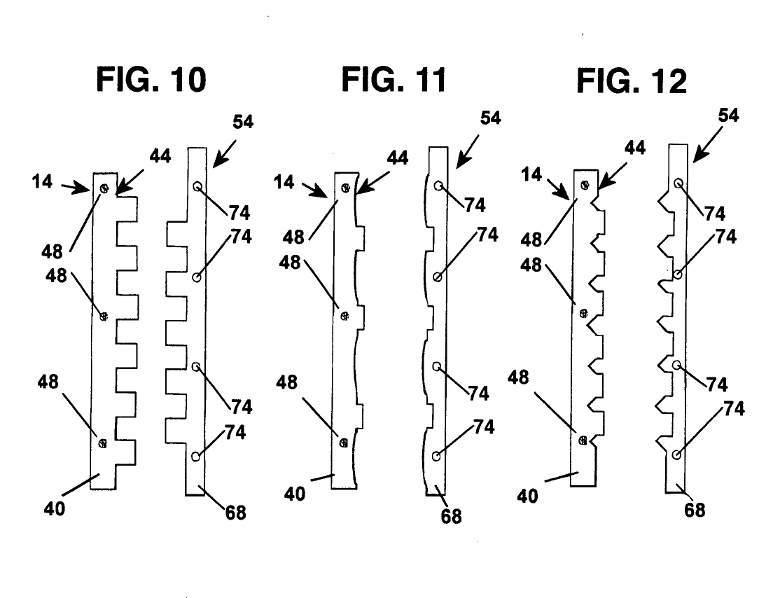

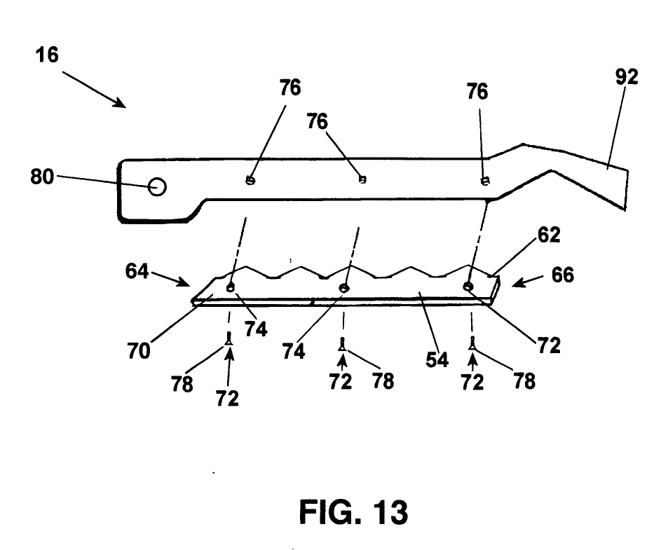

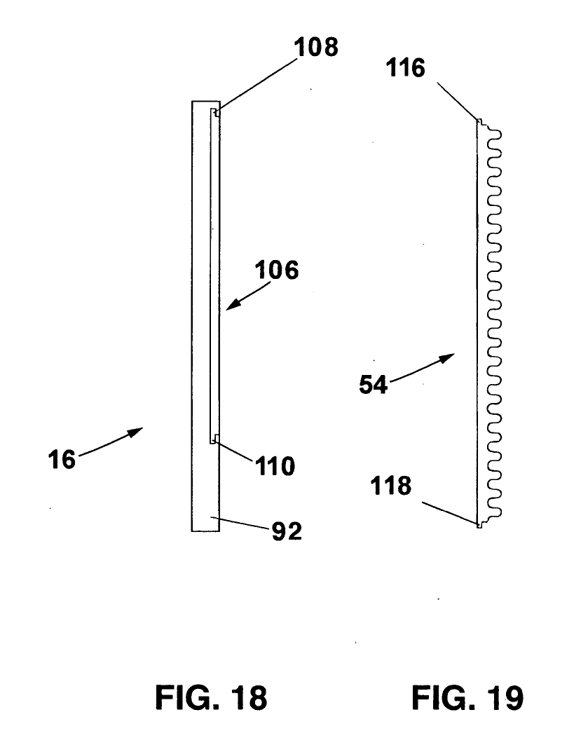

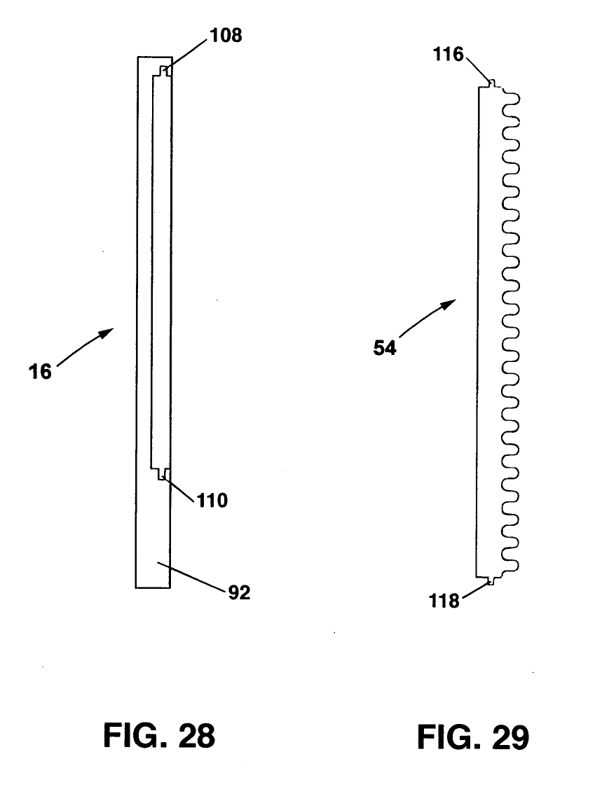

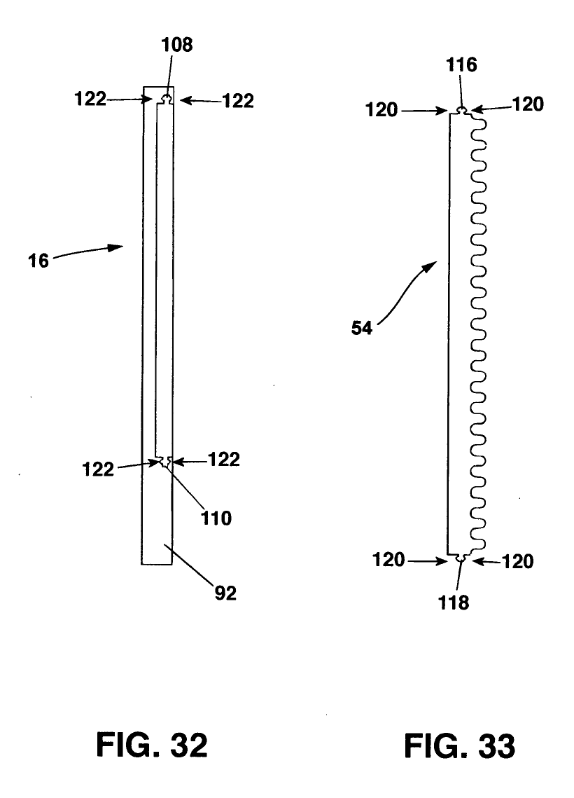

In the present invention, as shown in FIGS. 6-40 and as described below, unless otherwise stated stationary cutting blade 14 and cutting member 54 are as described above in connection with the prior art paper trimmers. Consequently, in one embodiment of the invention shown in FIGS. 6-11, stationary cutting blade 14 also has holes 48 that interact with screws 46 to hold stationary cutting blade 14 in place in platform recess 32 as described above. Cutting member 54 of the present invention also has holes 74 that interact with screws 72 to hold cutting member 54 in contact with movable cutting arm 16. By removing screws 46 and 66, stationary cutting blade 14 and cutting member 54 are removed from the platform recess 32 of platform 12 and from the movable cutting arm 16, respectively. By placing the desired stationary cutting blade 14 in place in platform recess 32 and inserting screws 46 through holes 48 into holes 50 in platform recess 32, the newly desired stationary cutting blade 14 is securely fastened to platform 12 in platform recess 32. Likewise, by placing the desired corresponding cutting member 54 in place in contact with the movable cutting arm 16 and inserting screws 72 through holes 74 into holes 76 in movable cutting arm 16, the newly desired cutting member 54 is securely fastened to movable cutting arm 16.

As stated above, in prior art paper trimmers the cutting edge 44 of the stationary cutting blade 14 and the cutting edge 62 of the movable cutting arm 16 have straight well-defined edges that interact to cut the paper in a single straight line by a shearing motion. The present invention modifies both the stationary cutting blade 14 and the cutting edge 62 of the cutting member 54 of the movable cutting arm 16 to provide well defined edges that are not straight or linear for their entire lengths and in fact may have curves or other shapes along their well defined edges.

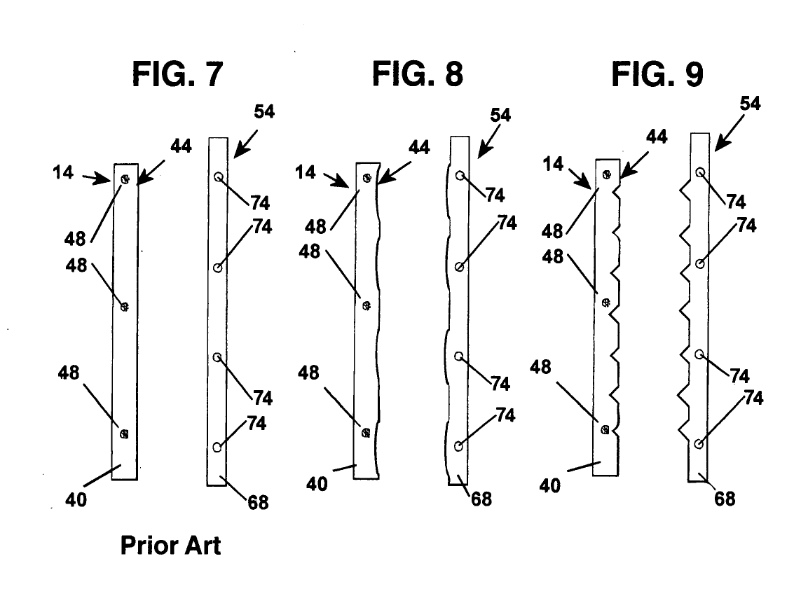

For example, as shown in FIGS. 7-12, cutting edge 44 and cutting edge 62 have various designs that complement each other as they interact to cut the paper. Of course, in order for cutting edge 44 and cutting edge 62 to meet to cut the paper with shearing motion, the designs or patterns on cutting edge 44 and cutting edge 62, when both cutting edge 44 and cutting edge 62 are in place in the platform recess 32 and on movable cutting arm 16, respectively, must be precisely aligned. This is accomplished by correctly aligning the cutting edge 44 and cutting edge 62 and then precisely aligning the holes 48 and 68 in stationary cutting blade 14 and cutting member 54, respectively, to ensure that this alignment continues when stationary cutting blade 14 and cutting member 54 are positioned in platform recess 32 and on movable cutting arm 16, respectively.

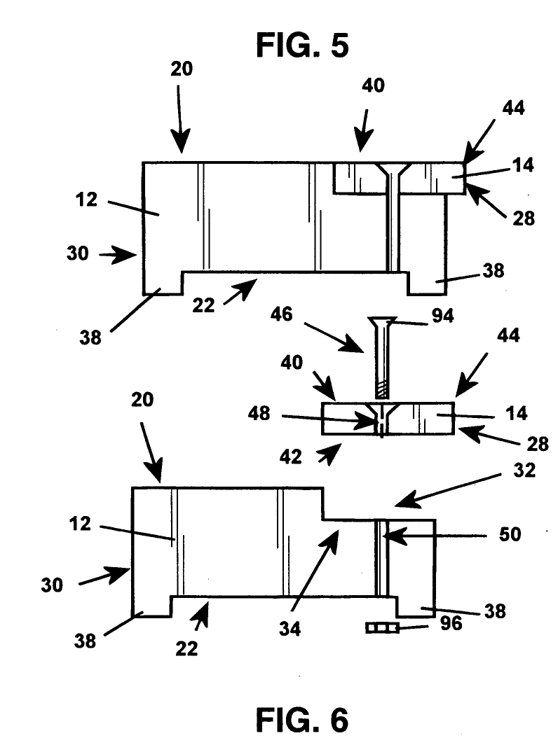

As described, stationary cutting blade 14 in this embodiment is held in place in platform recess 32 by removable means such as screws 46 so that a specific stationary cutting blade 14 can be used with the invention as desired. However, other removable means of attaching the stationary cutting blade 14 to the platform 12 in platform recess 32 may be used as will occur to those skilled in the art and are intended to be part of this invention. Without limiting the possible means for such removable attachment, as shown in FIGS. 5 and 6, screws 46 could be replaced with bolts 94 extending through holes 48.

In this embodiment, holes 50, instead of being threaded, are cylindrical so that the bolts 94 can pass through holes 50. In this embodiment as well, a nut 96 is secured to the ultimate end of the bolt 94 next to hole 50 on the bottom surface 22 of platform 12 to secure the bolts 94, and thereby the stationary cutting blade 14, in position. Likewise, although the cutting member 54 in this embodiment is held in place against the movable cutting arm 16 by removable means such as screws 72, other removable means of attaching the cutting member 54 to the movable cutting arm may be used as will occur to those skilled in the art and are intended to be part of this invention.

Without limiting the possible means for such removable attachment, screws 72 could be replaced with bolts 98 extending through holes 74. In this embodiment, holes 76, instead of being threaded, are cylindrical so that the bolts 98 can pass through holes 76. In this embodiment as well, a nut 100 is secured to the ultimate end of the bolt 98 next to hole 70 to secure the bolts 98, and thereby the cutting member 54, in position.

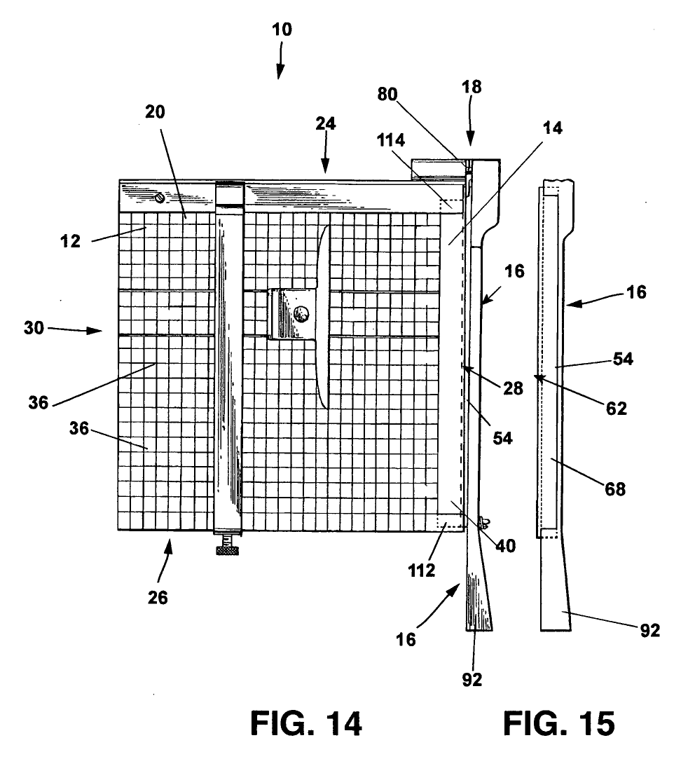

An alternate embodiment of the paper trimmer 10 is shown in FIGS. 14-40. In this embodiment, the paper trimmer 10 is modified so that platform 12 has a pair of blade-retaining notches 102, 104 on opposite ends of platform recess 32 and movable cutting arm 16 has a movable arm recess 106 with a pair of cutting arm-retaining notches 108, 110 for holding and positioning the stationary cutting blade 14 and cutting member 54, respectively.

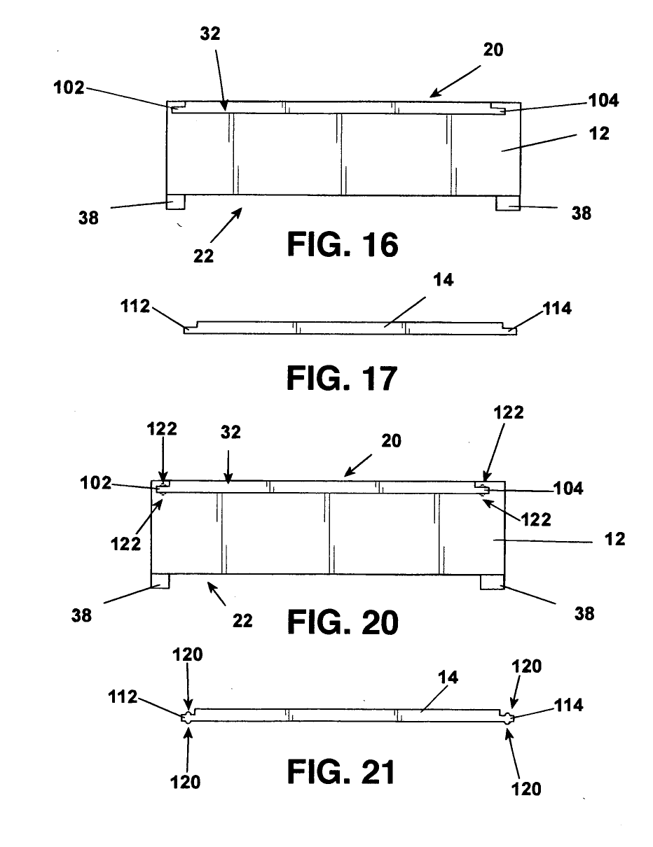

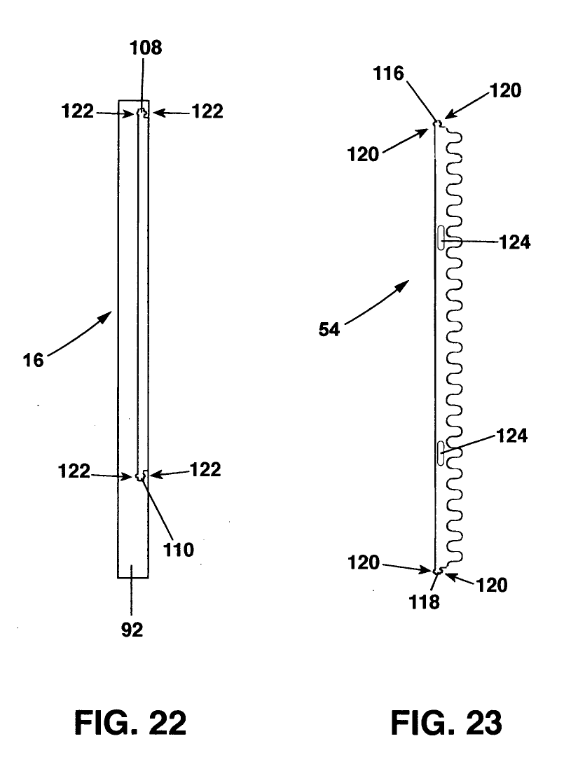

Platform recess 32 is modified, as shown in FIGS. 14 and 16 so that it does not extend from the upper side 24 to the lower side 26. Instead, the ends of platform recess 32 near the upper side 24 and lower side 26 are made of the material of the platform 12 or else are added and attached to the platform 12 and rabbeted notches 102, 104 are placed at the upper side 24 and lower side 26, respectively, of platform recess 32. In addition, as shown in FIGS. 15 and 22 movable cutting arm 16 is modified by placing rabbeted notches 108, 110 on movable cutting arm 16 as will be described hereafter.

In this embodiment, stationary cutting blade 14 (FIG. 17) and its corresponding cutting member 54 (FIG. 23) have their opposed ends modified to allow the stationary cutting blade 14 and cutting member 54 to interact with and be held in place on platform recess 32 and on movable cutting arm 16, respectively. The stationary cutting blade 14 has fingers 112 and 114 located on opposite ends of stationary cutting blade 14 that extend away from stationary cutting blade 14. Fingers 112, 114 are preferably planar in a plane parallel to the plane of the body of stationary cutting blade 14. These fingers 112, 114 are inserted into the rabbeted notches 102, 104, respectively.

The dimensions of fingers 112, 114 and notches 102, 104 are such that fingers 112, 114 may be slid into notches 102, 104 with frictional resistance. This configuration produces a sliding frictional fit between the fingers 112, 114 and the rabbeted notches 102, 104, respectively, which holds the stationary cutting blade 14 in position in platform recess 32. This allows the stationary cutting blade 14 to be inserted and installed on platform recess 32 with only finger pressure, but firmly positions the stationary cutting blade 14 on platform recess 32 in proper alignment.

Movable arm recess 106 is a channel formed in the lower edge 56 of movable arm 16, as shown in FIGS. 15 and 22 and preferably does not extend completely to the pivot end 58 or to the handle end 60 of movable arm 16. Instead, the ends of movable arm recess 106 near the pivot end 58 and handle end 60 are made of the material of the movable arm 16 or else are added and attached to the movable arm 16. Rabbeted notches 108, 110 are placed at the pivot end 58 and handle end 60, respectively, of movable arm recess 106.

The cutting member 54 has fingers 116 and 118 located on opposite ends of cutting member 54 that extend away from cutting member 54. Fingers 116, 118 are preferably planar in a plane parallel to the plane of the body of cutting member 54. These fingers 116, 118 are inserted into the rabbeted notches 108, 110, respectively. This configuration produces a sliding fit between the fingers 116, 118 and the rabbeted notches 108, 110, respectively. This allows the cutting member 54 to be inserted and installed on movable cutting arm recess 92 of movable cutting arm 16 with only finger pressure, but firmly positions the cutting member 54 on movable cutting arm 16 in proper alignment.

The dimensions of fingers 116, 118 and notches 108, 110 are such that fingers 116, 118 may be slid into notches 108, 110 with frictional resistance. This configuration produces a sliding frictional fit between the fingers 116, 118 and the rabbeted notches 108, 110, respectively, which holds the cutting member 54 in position in the movable cutting arm recess 92 of movable cutting arm 16. This allows the cutting member 54 to be inserted and installed on movable cutting arm 16 with only finger pressure, but firmly positions the cutting member 54 on movable cutting arm 16 in proper alignment.

In a variant of this embodiment shown in FIGS. 20-23, fingers 112, 114 and 108, 110 are modified to include at least one protrusion 120 extending outwardly from the surface of fingers 112, 114 and 108,110. Notches 102, 104 and 96, 98 are also modified to have a corresponding detent 122 matching the configuration and dimensions of the protrusions 120 on fingers 112, 114 and 108, 110. Protrusion 120 may be placed on one or both opposing sides of fingers 112, 114 and 108, 110 and may take the form of semi-spheres, ovals, three dimensional geometric bodies, ridges, ramps, squares, rectangles, pyramids, free form curves and free form shapes, etc. as will be clear to those skilled in the art. The function of the interaction between protrusions 120 and detents 122 is to mechanically hold the fingers 112, 114 and 108, 110 in the notches 102, 104 and 96, 98 in place of or in addition to the frictional contact that occurs between fingers 112, 114 and 108, 110 in the notches 102, 104 and 96, 98.

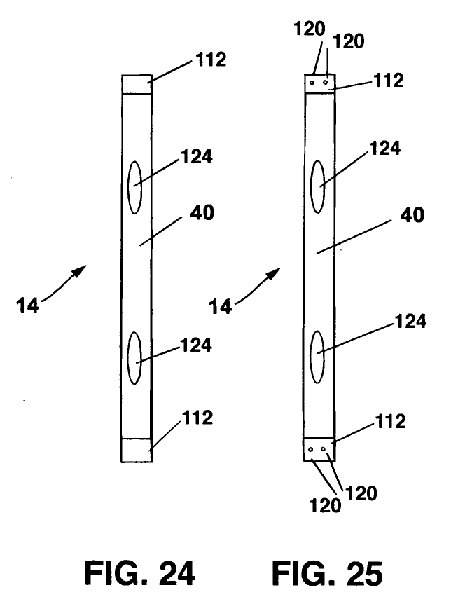

To assist the user in inserting the stationary cutting blade 14 into the notches 102, 104, the top surface 40 of the stationary cutting blade 14 may have a frictional portion 124 (FIG. 24) that is slightly roughened, has a series of parallel or cross-hatched lines or is otherwise made more frictional than the rest of the top surface 40 to allow the user to contact the frictional portion 124 with his or her fingers and move the stationary cutting blade 14 into or out of secure contact between the between fingers 112, 114 and notches 102, 104.

Likewise, to assist the user in inserting the cutting member 54 into the notches 108, 110, the top surface 68 of the cutting member 54 may also have a frictional portion 124 (FIG. 23) that is slightly roughened, has a series of parallel or cross-hatched lines or is otherwise made more frictional than the rest of the top surface 68 to allow the user to contact the frictional portion 124 with his or her fingers and move the cutting member 54 into or out of secure contact between the between fingers 116, 118 and notches 108, 110.

When the fingers 108, 110 and 112, 114 of cutting member 54 and stationary cutting blade 14 are inserted into their corresponding in the notches 96, 98 and 102, 104, the paper trimmer 10 in this embodiment is ready to be used. Stationary cutting blade 14 and cutting member 54 are sufficiently firmly held in their retaining recesses so that, when the movable cutting arm 16 moves cutting member 54 into and away from contact with the stationary cutting blade 14, stationary cutting blade 14 and cutting member 44 remain in their respective recesses.

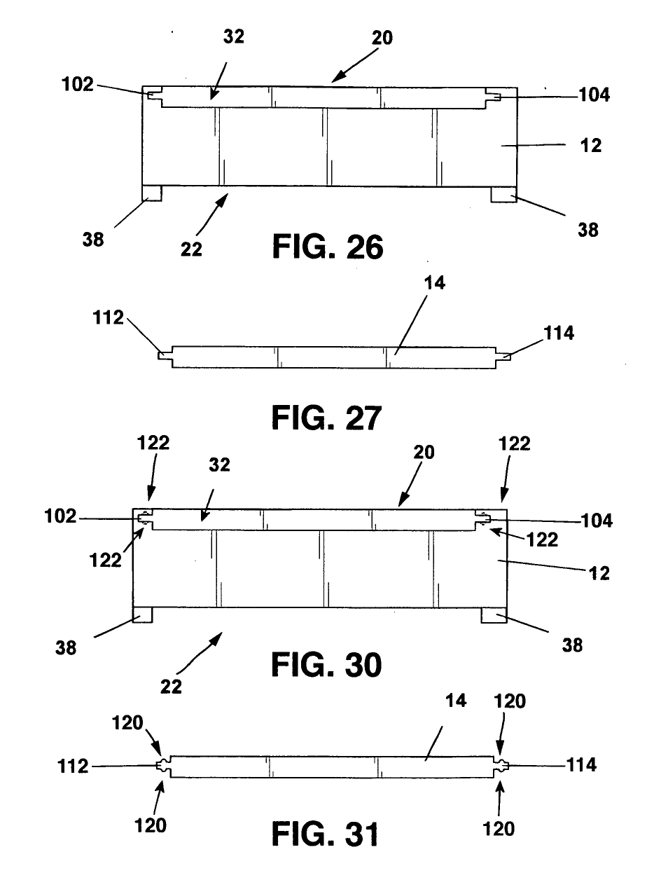

FIGS. 26-33 show an additional variant of the invention. In this embodiment, the fingers, 108, 110 and 112, 114, instead of extending from the bottom surface 70 of cutting member 54 or bottom surface 42 of stationary cutting blade 14 are located between the top surface 68 and bottom surface 70 and top surface 40 and bottom surface 42, respectively, of cutting member 54 and stationary cutting blade 14. The platform recess 32 and movable arm recess 106 are also modified slightly to conform to the shape of the stationary cutting blade 14 and cutting member 54. The corresponding notches 96, 98 and 102, 104, are located to mate with the fingers 108, 110 and 112, 114 as described above. Because the fingers, 108, 110 and 112, 114 are located between the top surface 68 and bottom surface 70 and top surface 40 and bottom surface 42, respectively of cutting member 54 and stationary cutting blade 14, the stationary cutting blade 14 may be made thicker than the stationary cutting blade of FIGS. 16-23. In this embodiment, the fingers 108, 110 and 112, 114 may also each include one or more protrusions 120 extending outwardly from fingers 108, 110 and 112, 114 as described above. Correspondingly, the notches 102, 104 and 96, 98 may also be modified to have a corresponding detent 122 matching the configuration and dimensions of the protrusions 120 on fingers 112, 114 and 108, 110.

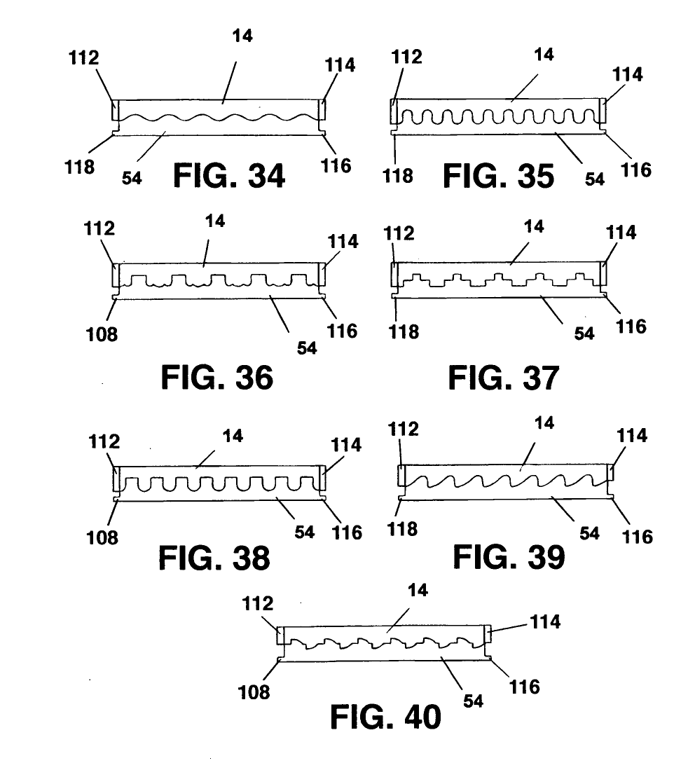

FIGS. 34-40 show additional variants of the stationary cutting blades 14 and their corresponding cutting members 54 of the embodiments of FIGS. 12-31 in an intermeshed condition. Of course, each of these cutting blades 14 and cutting members 54 may be configured as described in connection with any of the embodiments or variants described above and shown in FIGS. 14-33 and may also be configured in the embodiments and variants described above and shown in FIGS. 6-13.

A significant feature of this embodiment of the present invention is that the stationary cutting blade 14 and its corresponding cutting member 54 can be easily and rapidly removed and replaced with another stationary cutting blade 14 and corresponding cutting member 54 pair so as to cut a different edge configuration in the sheet being sheared by the paper trimmer 10. This embodiment of the invention allows the various stationary cutting blades 14 and corresponding cutting members 54 to be inserted and removed at will without the necessity for using screws 46, 66 with the problems of aligning the screws 46, 66 with their respective holes and with the possibility of losing the screws 46, 66.

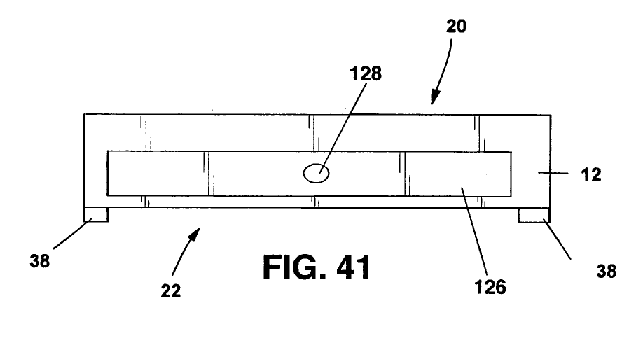

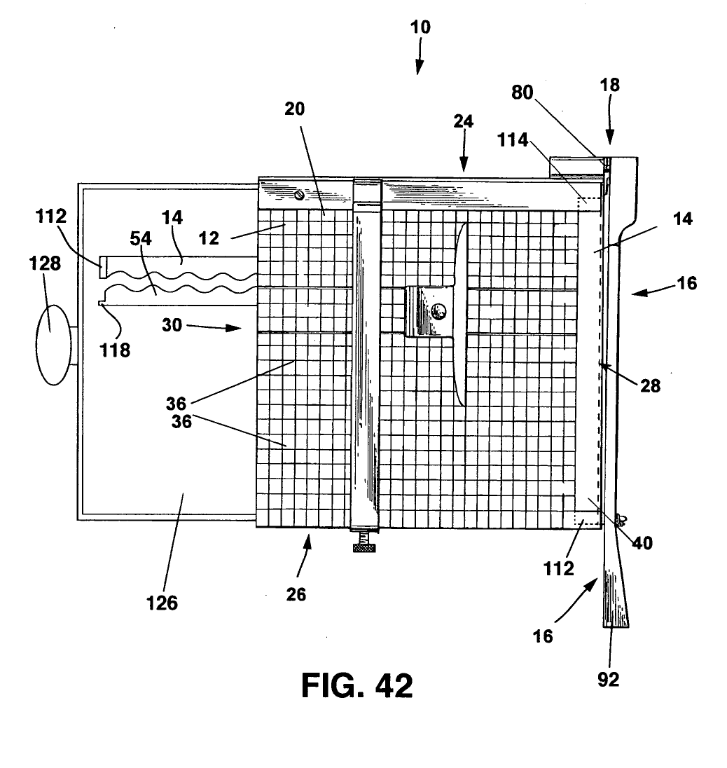

The paper trimmer 10 in all embodiments may also include a drawer 126 as shown in FIGS. 41-42. Drawer 126 is preferably located in the material of platform 12 so that drawer 126, when closed, is entirely within platform 12. Drawer 126 may be located on the side of platform 12 along the upper side, 24, lower side 26 or opposed edge 30 of platform 12 and may have a knob 128 in whatever form to allow the user to better grasp the drawer 126 to open or close it. Drawer 126 may hold a variety of stationary cutting blades 14 and their corresponding cutting members 54 or any other useful instruments or materials.

Stationary cutting blade 14 and cutting member 54 are preferably made of metal so as to be strong, able to hold a sharp cutting edge, shear cleanly and have a long cutting life. In this regard, it is intended that hardened and ground high carbon steel or hard stainless steel be used as the material for stationary cutting blade 14 and cutting member 54. Other materials such as ceramics or hardened plastics may also be used as will be clear to those skilled in the art.

Although the preferred embodiment of the paper trimmer 10 is for both the stationary cutting blade 14 and the cutting member 54 be removable, it is within the scope of the invention for either stationary cutting blade 14 or the cutting member 54 or both be permanently attached to the paper trimmer 10. This may be accomplished by forming the stationary cutting blade 14 or the cutting member 54 integrally with the platform 12 and movable cutting arm 16, respectively, or by permanently attaching the stationary cutting blade 14 or the cutting member 54 to the platform 12 and movable cutting arm 16, respectively.

In addition, the paper trimmer 10 has been described in connection with cutting paper or similar material. It is clear that the trimmer 10 could be used to cut any material that is amenable to cutting by a shearing motion. Such material includes, but is not limited to, cardboard, plastics, composites, thin metals, foils or organic material.

In operation with all of the embodiments and variants, the operator chooses a desired stationary cutting blade 14 according to the pattern he or she wishes to cut into the paper. The desired stationary cutting blade 14 is placed in platform recess 32 and secured by either screws 46 or the interaction between notches 102, 104 and fingers 112, 114. A cutting member 54 having a cutting edge 62 corresponding in shape to the stationary cutting blade 14 is selected and attached to the body of movable cutting arm 16 as described above, either through the use of screws 72 or through the interaction of notches 108, 110 and fingers 116, 118. The user then places the paper to be cut on the top surface 20 of platform 12. The handle 92 of the movable cutting arm 16 is grasped and the movable cutting arm 16 rotated around pivot 18 so that the cutting edge 62 of cutting member 54 contacts the paper on platform 12 at cutting edge 44 of stationary cutting blade 16. Shearing action between the cutting edge 62 and the cutting edge 44 cuts the paper with the desired pattern.

The present invention has been described in connection with certain embodiments and dimensions. It is to be understood, however, that the description given herein has been given for the purpose of explaining and illustrating the invention and are not intended to limit the scope of the invention. For example, specific examples of the complementary patterns on cutting edges 44 and 56 of stationary cutting blade 14 and cutting member 54, respectively, have been shown. However, it is clear than an infinite number of such patterns may be created and that various elements of certain patterns may be combined to produce even more patterns. It is not intended that the invention be limited to the specific designs shown. Rather, the invention is intended to encompass any complementary design that may be placed on the stationary cutting blade 14 along the cutting edge 44 and the cutting member 54 along the cutting edge 62.

Further, the use of movable arm recess 106 has been described in connection with an embodiment involving the use of rabbeted notches 108, 110 on movable arm recess 106 and fingers 116, 118 on cutting member 54. However, movable arm recess 106 could also be used to position cutting member 54 in the other embodiments described herein. In addition, in embodiments not involving notches 108, 110 and fingers 116, 118, movable arm recess 106 could extend completely from the pivot end 58 to the handle end 60 of the movable arm 16. Further, the method of securing stationary cutting blade 14 to platform 12 or securing cutting member 54 to movable arm 16 could be a combination of respective fingers 112, 114, 108, 110 and notches 102, 104, 108, 110 and screws 46 or screws 72 or bolts 94 and nuts 96 or bolts 98 and nuts 100.

In a variant of the embodiments described above, the stationary cutting blade 14 may be attached to the platform 12 by any of the methods described above. In this way, a variety of stationary cutting blades 14 may be used with the device 10. However, instead of attaching a removable cutting member 54 to the movable cutting arm 16 as described above, the cutting member 54 may be permanently secured to the movable cutting arm 16 by, for example, forming the cutting member 54 in the movable cutting arm 16, adhesives, screws 72, bolts 98 and nuts 100 or other methods that will occur to those skilled in the art, and the entire movable cutting arm 16 may be removed from the pivot 18 and another movable cutting arm 16 with a different cutting member 54 attached in its place.

It is to be further understood that changes and modifications to the descriptions given herein will occur to those skilled in the art. Therefore, the scope of the invention should be limited only by the scope of the following claims.

What is claimed is:

1. A trimmer comprising:
a platform having a planar top surface, the top surface having a cutting side, an upper side and a lower side;
a stationary cutting blade having a top surface and a cutting edge, the stationary cutting blade attached to the top surface of the platform along the cutting side so that the top surface of the stationary cutting blade is co-planar with the top surface of the platform wherein the cutting edge of the stationary cutting blade has a non-linear cutting edge;
a movable cutting arm having a lower edge, a pivot end and a handle end, the movable cutting arm also having a cutting member with a cutting edge, the cutting edge of the cutting member located near the lower edge of the movable cutting arm, the movable cutting arm connected to the platform by a pivot, wherein the cutting edge of the cutting member has a non-linear cutting edge corresponding in shape to the shape of the cutting edge of the stationary cutting blade and wherein the movable cutting arm is vertically disposed and movable so that the cutting edge of the cutting member interacts with the cutting edge of the stationary cutting blade to cut, by a shearing action, the paper or other material that is desired to be cut.

2. The trimmer of claim 1 wherein the stationary cutting blade is removable from the platform.

3. The trimmer of claim 2 wherein:
the platform has a recess for receiving the stationary cutting blade, the platform recess having an upper surface, the platform recess formed along the cutting side of the platform and extending from near the upper side to near the lower side, each end of the platform recess near the upper side and the lower side having rabbeted notches extending into the platform from the upper side and the lower side of the platform recess, the notches formed to hold and position the stationary cutting blade; and
the stationary cutting blade has fingers located on opposite ends of the stationary cutting blade that extend away from stationary cutting blade, wherein the dimensions of the fingers extending away from the stationary cutting blade and the notches formed at the ends of the platform recess are such that the fingers extending away from the stationary cutting blade may be slid into the notches formed at the ends of the platform recess.

4. The trimmer of claim 3 wherein the fingers extending away from the stationary cutting blade and the notches formed near the upper side and the lower side of the platform recess are dimensioned so that frictional resistance between the respective fingers and notches holds the stationary cutting blade in position in the platform recess.

5. The trimmer of claim 3 wherein:
the fingers extending away from the stationary cutting blade include at least one protrusion extending outwardly from the surface of the fingers extending away from the stationary cutting blade; and
the notches formed at the ends of the platform recess have a detent matching the configuration and dimensions of each protrusions on the fingers extending away from the stationary cutting blade;
whereby the interaction between the protrusions and detents mechanically holds the fingers extending away from the stationary cutting blade in the notches formed at the ends of the platform recess.

6. The trimmer of claim 2 wherein:
the trimmer further comprises screws for removably attaching the stationary cutting blade to the platform;
the platform has a recess for receiving the stationary cutting blade, the platform recess having an upper surface with holes adapted to receive the screws, the holes having a thread to match and interact with the threads on the screws;
the stationary cutting blade has holes extending entirely through the stationary cutting blade, the holes in the stationary cutting blade corresponding in location to the holes in the platform recess when the stationary cutting blade is in position in the platform recess; and
the screws extend through the holes in the stationary cutting blade into the upper surface of the platform recess where the holes in the upper surface of the platform recess receive the screws;
whereby the screws hold the stationary cutting blade in position in the platform recess.

7. The trimmer of claim 2 wherein the trimmer further comprises bolts and nuts for removably attaching the stationary cutting blade to the platform and wherein:
the platform has a recess for receiving the stationary cutting blade, the platform recess having an upper surface with holes extending from the upper surface through the platform to receive the bolts;
the stationary cutting blade has holes extending entirely through the stationary cutting blade aligned with the holes in the recess when the stationary cutting blade is located in the platform recess;
the bolts extend through the holes in the stationary cutting blade and through the holes extending from the upper surface of the platform recess through the platform; and
the nuts are attached to the bolts to hold the stationary cutting blade in immovable position in the platform recess in the platform.

8. The trimmer of claim 1 wherein the cutting member is removable from the movable cutting arm.

9. The trimmer of claim 8 wherein:
the movable cutting arm has a recess for receiving the cutting member, the movable cutting arm recess having an upper surface, the movable cutting arm recess formed in the lower edge of the movable cutting arm and extending from near the pivot end to near the handle end, each end of the movable cutting arm recess near the pivot end and the handle end having rabbeted notches extending into the movable cutting arm from the pivot end and the handle end of the movable cutting arm recess, the notches holding and positioning the cutting member; and
the cutting member has fingers located on opposite ends of the cutting member that extend away from cutting member, wherein the dimensions of the fingers extending away from the cutting member and the notches formed at the ends of the movable cutting arm recess are such that the fingers extending away from the cutting member may be slid into the notches formed at the ends of the movable cutting arm recess.

10. The trimmer of claim 9 wherein the fingers extending away from the cutting member and the notches formed at the ends of the movable cutting arm recess near the pivot end and the handle end of the movable cutting arm recess are dimensioned so that frictional resistance between the respective fingers and notches holds the cutting member in position in the movable cutting arm recess.

11. The trimmer of claim 9 wherein:
the fingers extending away from the cutting member include at least one protrusion extending outwardly from the surface of the fingers extending away from the cutting member; and
the notches formed at the ends of the movable cutting arm recess have a detent matching the configuration and dimensions of each protrusions on the fingers extending away from the cutting member;
whereby the interaction between the protrusions and detents mechanically holds the fingers extending away from the cutting member in the notches formed at the ends of the movable cutting arm recess.

12. The trimmer of claim 8 wherein:
the trimmer further comprises screws for removably attaching the cutting member to the movable cutting arm;
the movable cutting arm has a recess for receiving the cutting member, the movable cutting arm recess having an upper surface with holes adapted to receive the screws, the holes having a thread to match and interact with the threads on the screws;
the cutting member has holes extending entirely through the cutting member, the holes in the cutting member corresponding in location to the holes in the movable cutting arm when the cutting member is in position in the movable cutting arm recess; and
the screws extend through the holes in the cutting member into the upper surface of the movable cutting arm recess where the holes in the upper surface of the movable cutting arm recess receive the screws;
whereby the screws hold the cutting member in position in the movable cutting arm recess.

13. The trimmer of claim 8 wherein the trimmer further comprises bolts and nuts for removably attaching the cutting member to the movable cutting arm and wherein:
the movable cutting arm has a recess for receiving the cutting member, the movable cutting arm recess having an upper surface with holes extending from the upper surface through the movable cutting arm to receive the bolts;
the cutting member has holes extending entirely through the cutting member aligned with the holes in the movable cutting arm recess when the cutting member is located in the movable cutting arm recess;
the bolts extend through the holes in the cutting member and through the holes extending from the upper surface of the movable cutting arm recess through the movable cutting arm; and
the nuts are attached to the bolts to hold the cutting member in immovable position in the movable cutting arm recess in the movable cutting arm.

14. The trimmer of claim 1 wherein the platform includes a drawer formed in the platform.

15. A trimmer comprising:
a platform having a planar top surface, the top surface having a cutting side, an upper side and a lower side;
a stationary cutting blade having a top surface and a cutting edge, the stationary cutting blade attached to the top surface of the platform along the cutting side so that the top surface of the stationary cutting blade is co-planar with the top surface of the platform wherein the cutting edge of the stationary cutting blade has a non-linear cutting edge and wherein the stationary cutting blade is removable from the platform;
a movable cutting arm having a lower edge, a pivot end and a handle end, the movable cutting arm also having a cutting member with a cutting edge, the cutting edge of the cutting member located near the lower edge of the movable cutting arm, the movable cutting arm connected to the platform by a pivot, wherein the cutting edge of the cutting member has a non-linear cutting edge corresponding in shape to the shape of the cutting edge of the stationary cutting blade and wherein the movable cutting arm is vertically disposed and movable so that the cutting edge of the cutting member interacts with the cutting edge of the stationary cutting blade to cut, by a shearing action, the paper or other material that is desired to be cut wherein the cutting member is removable from the movable cutting arm.

16. The trimmer of claim 15 wherein the stationary cutting blade is attached to the platform by means chosen from the group consisting of:
(a) the platform having a recess for receiving the stationary cutting blade, the platform recess having an upper surface, the platform recess formed along the cutting side of the platform and extending from near the upper side to near the lower side, each end of the platform recess near the upper side and the lower side having rabbeted notches extending into the platform from the upper side and the lower side of the platform recess, the notches formed to hold and position the stationary cutting blade; and
the stationary cutting blade having fingers located on opposite ends of the stationary cutting blade that extend away from stationary cutting blade, wherein the dimensions of the fingers extending away from the stationary cutting blade and the notches formed at the ends of the platform recess are such that the fingers extending away from the stationary cutting blade may be slid into the notches formed at the ends of the platform recess;
(b) screws for removably attaching the stationary cutting blade to the platform;
the platform having a recess for receiving the stationary cutting blade, the platform recess having an upper surface with holes adapted to receive the screws, the holes having a thread to match and interact with the threads on the screws;
the stationary cutting blade having holes extending entirely through the stationary cutting blade, the holes in the stationary cutting blade corresponding in location to the holes in the platform recess when the stationary cutting blade is in position in the platform recess; and
the screws extend through the holes in the stationary cutting blade into the upper surface of the platform recess where the holes in the upper surface of the platform recess receive the screws;
whereby the screws hold the stationary cutting blade in position in the platform recess;
(c) bolts and nuts for removably attaching the stationary cutting blade to the platform and wherein:
the platform has a recess for receiving the stationary cutting blade, the platform recess having an upper surface with holes extending from the upper surface through the platform to receive the bolts;
the stationary cutting blade has holes extending entirely through the stationary cutting blade aligned with the holes in the recess when the stationary cutting blade is located in the platform recess;
the bolts extend through the holes in the stationary cutting blade and through the holes extending from the upper surface of the platform recess through the platform; and
the nuts are attached to the bolts to hold the stationary cutting blade in immovable position in the platform recess in the platform.

17. The trimmer of claim 15 wherein the cutting member is attached to the movable cutting arm by means chosen from the group consisting of:
(a) the movable cutting arm having a recess for receiving the cutting member, the movable cutting arm recess having an upper surface, the movable cutting arm recess formed in the lower edge of the movable cutting arm and extending from near the pivot end to near the handle end, each end of the movable cutting arm recess near the pivot end and the handle end having rabbeted notches extending into the movable cutting arm from the pivot end and the handle end of the movable cutting arm recess, the notches holding and positioning the cutting member; and
the cutting member having fingers located on opposite ends of the cutting member that extend away from cutting member, wherein the dimensions of the fingers extending away from the cutting member and the notches formed at the ends of the movable cutting arm recess are such that the fingers extending away from the cutting member may be slid into the notches formed at the ends of the movable cutting arm recess;
(b) screws for removably attaching the cutting member to the movable cutting arm;
the movable cutting arm having a recess for receiving the cutting member, the movable cutting arm recess having an upper surface with holes adapted to receive the screws, the holes having a thread to match and interact with the threads on the screws;
the cutting member has holes extending entirely through the cutting member, the holes in the cutting member corresponding in location to the holes in the movable cutting arm when the cutting member is in position in the movable cutting arm recess; and
the screws extend through the holes in the cutting member into the upper surface of the movable cutting arm recess where the holes in the upper surface of the movable cutting arm recess receive the screws;
whereby the screws hold the cutting member in position in the movable cutting arm recess;
(c) bolts and nuts for removably attaching the cutting member to the movable cutting arm and wherein:
the movable cutting arm has a recess for receiving the cutting member, the movable cutting arm recess having an upper surface with holes extending from the upper surface through the movable cutting arm to receive the bolts;
the cutting member has holes extending entirely through the cutting member aligned with the holes in the movable cutting arm recess when the cutting member is located in the movable cutting arm recess;
the bolts extend through the holes in the cutting member and through the holes extending from the upper surface of the movable cutting arm recess through the movable cutting arm; and
the nuts are attached to the bolts to hold the cutting member in immovable position in the movable cutting arm recess in the movable cutting arm.

18. A trimmer comprising:
a platform having a planar top surface, the top surface having a cutting side, an upper side and a lower side;
a stationary cutting blade having a top surface and a cutting edge, the stationary cutting blade attached to the top surface of the platform along the cutting side so that the top surface of the stationary cutting blade is co-planar with the top surface of the platform wherein the cutting edge of the stationary cutting blade has a non-linear cutting edge and wherein the stationary cutting blade is removable from the platform;
a movable cutting arm having a lower edge, a pivot end and a handle end, the movable cutting arm also having a cutting member with a cutting edge, the cutting edge of the cutting member located near the lower edge of the movable cutting arm, the movable cutting arm connected to the platform by a pivot, wherein the cutting edge of the cutting member has a non-linear cutting edge corresponding in shape to the shape of the cutting edge of the stationary cutting blade and wherein the movable cutting arm is vertically disposed and movable so that the cutting edge of the cutting member interacts with the cutting edge of the stationary cutting blade to cut, by a shearing action, the paper or other material that is desired to be cut wherein the cutting member is removable from the movable cutting arm;
wherein the platform has a recess for receiving the stationary cutting blade, the platform recess having an upper surface, the platform recess formed along the cutting side of the platform and extending from near the upper side to near the lower side, each end of the platform recess near the upper side and the lower side having rabbeted notches extending into the platform from the upper side and the lower side of the platform recess, the notches formed to hold and position the stationary cutting blade; and
wherein the stationary cutting blade has fingers located on opposite ends of the stationary cutting blade that extend away from stationary cutting blade, wherein the dimensions of the fingers extending away from the stationary cutting blade and the notches formed at the ends of the platform recess are such that the fingers extending away from the stationary cutting blade may be slid into the notches formed at the ends of the platform recess; and
wherein the movable cutting arm has a recess for receiving the cutting member, the movable cutting arm recess having an upper surface, the movable cutting arm recess formed in the lower edge of the movable cutting arm and extending from near the pivot end to near the handle end, each end of the movable cutting arm recess near the pivot end and the handle end having rabbeted notches extending into the movable cutting arm from the pivot end and the handle end of the movable cutting arm recess, the notches holding and positioning the cutting member; and
wherein the cutting member has fingers located on opposite ends of the cutting member that extend away from cutting member, wherein the dimensions of the fingers extending away from the cutting member and the notches formed at the ends of the movable cutting arm recess are such that the fingers extending away from the cutting member may be slid into the notches formed at the ends of the movable cutting arm recess.
